(19) United States
(12) Patent Application Publication
(10) Pub. No.: US 2026/0244013 A1
(43) Pub. Date: Aug. 20, 2026

(54) HEAD-UP DISPLAY APPARATUS AND VEHICLE

(71) Applicant: SEIKO EPSON CORPORATION, Tokyo (JP)

(72) Inventor: Eiji MORIKUNI, MATSUMOTO-SHI, NAGANO-KEN (JP)

(21) Appl. No.: 19/538,508

(22) Filed: Feb. 12, 2026

(30) Foreign Application Priority Data
Feb. 14, 2025 (JP) 2025-021998

(51) Int. Cl. G02B 27/01; H04N 9/31

(52) U.S. Cl. CPC G02B 27/0101; H04N 9/3147; H04N 9/3164; H04N 9/3188

(57) ABSTRACT

A head-up display apparatus includes two or more display apparatuses each configured to emit display light; and a mirror configured to reflect the display light emitted from each of the display apparatuses, the display apparatuses each including an image generator configured to generate a video, a projection optical element configured to form an intermediate image corresponding to the video, and a display controller configured to control operation of displaying the video, the intermediate images formed by the display apparatuses being so disposed that portions of the intermediate images overlap with each other so that a single overlapped intermediate image is created, the display controller being configured to perform image processing on overlapping portions where the intermediate images overlap with each other in a way that a continuous video is created, and the mirror being configured to reflect the display light from the overlapped intermediate image so as to be visually recognized as a virtual image by an observer.

The present application is based on, and claims priority from JP Application Serial Number 2025-021998, filed Feb. 14, 2025, the disclosure of which is hereby incorporated by reference herein in its entirety.

### BACKGROUND

### 1. Technical Field

The present disclosure relates to a head-up display apparatus that displays a virtual image at the end of the line of sight, and a vehicle including the head-up display apparatus.

### 2. Related Art

There is a known head-up display apparatus including a drawing device that displays an image and a virtual image projection system that relays an image displayed by the drawing device to an intermediate screen, converts the image formed at the intermediate screen into a virtual image, and projects and displays the virtual image (WO 2019/130860).

WO 2019/130860 is an example of the related art.

In the apparatus described in WO 2019/130860, which includes a pair of the drawing device and the virtual image projection system, using a drawing device having a large aspect ratio to project a wide image having a large aspect ratio causes a problem of an increase in the size of the drawing device and hence the size of the entire optical system, and another problem of an increase in cost of the apparatus. To project a wide image, it is conceivable to project multiple virtual images side by side using multiple drawing devices and virtual image projection systems, but there is a possibility of missing image information at the boundary between the arranged virtual images, which puts stress on an observer.

### SUMMARY

A head-up display apparatus according to an aspect of the present disclosure includes: two or more display apparatuses each configured to emit display light; and a mirror configured to reflect the display light emitted from each of the display apparatuses, the display apparatuses each including an image generator configured to generate a video, a projection optical element configured to form an intermediate image corresponding to the video, and a display controller configured to control operation of displaying the video, the intermediate images formed by the display apparatuses being so disposed that portions of the intermediate images overlap with each other so that a single overlapped intermediate image is created, the display controller being configured to perform image processing on overlapping portions where the intermediate images overlap with each other in a way that a continuous video is created, and the mirror being configured to reflect the display light from the overlapped intermediate image so as to be visually recognized as a virtual image by an observer.

A vehicle according to another aspect of the present disclosure includes the head-up display apparatus described above.

### BRIEF DESCRIPTION OF THE DRAWINGS

FIG. 1 illustrates a vehicle incorporating a head-up display apparatus according to a first embodiment.

FIG. 2 is a conceptual view illustrating a video projector.

FIG. 3 is a cross-sectional view illustrating the head-up display apparatus.

FIG. 4 illustrates image generators.

FIG. 5 illustrates display elements, intermediate images, and an overlapped intermediate image.

FIG. 6 illustrates a video projector apparatus having a diffusion function.

FIG. 7 is a cross-sectional view illustrating a head-up display apparatus according to a second embodiment.

FIG. 8 illustrates a head-up display apparatus according to a third embodiment.

FIG. 9 illustrates a head-up display apparatus according to a fourth embodiment.

FIG. 10 illustrates a head-up display apparatus according to a fifth embodiment.

FIG. 11 illustrates a head-up display apparatus according to a sixth embodiment.

FIG. 12 illustrates a head-up display apparatus according to a seventh embodiment.

FIG. 13 illustrates a specific example of a display apparatus shown in FIG. 12.

FIG. 14 illustrates a variation of the display apparatus shown in FIG. 13.

FIG. 15 illustrates another specific example of the display apparatus shown in FIG. 12.

FIG. 16 illustrates a variation of the display apparatus shown in FIG. 15.

FIG. 17 illustrates still another specific example of the display apparatus shown in FIG. 12.

### DESCRIPTION OF EMBODIMENTS

### First Embodiment

A head-up display apparatus and the like of a first embodiment according to the present disclosure will be described below with reference to the drawings.

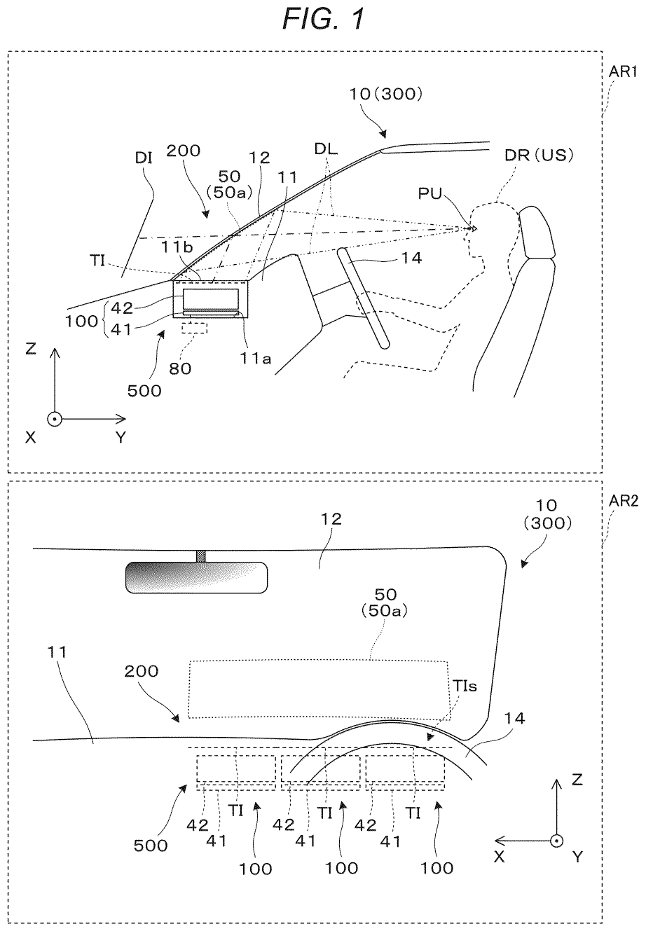

FIG. 1 is a conceptual view illustrating a head-up display apparatus 200 and a vehicle 300 equipped with the same. A region AR1 in FIG. 1 is a conceptual side cross-sectional view illustrating the head-up display apparatus 200 and the like. A region AR2 in FIG. 1 is a conceptual view illustrating the structure and the functions of the head-up display apparatus 200.

The head-up display apparatus 200 is incorporated in the vehicle 300, for example, an automobile 10, and includes a video projector 500 and a mirror 50. The video projector 500 displays any video or image. A driver DR, who is an observer US, observes the video or image displayed by the video projector 500 via the mirror 50. The vehicle 300 includes an engine and other drive mechanisms that cause the vehicle 300 to travel.

The video projector 500 is installed so as to be fitted into a recess 11a provided in a dashboard 11 of the automobile 10, and emits display light DL or video light corresponding to a video or an image containing driving-related information or the like upward to a portion where the mirror 50 is located. The video projector 500 is covered with a sheet-shaped, transparent protective cover 11b provided at the upper end of the recess 11a. The mirror 50 reflects the display light DL emitted from a display apparatus 100 of the video projector 500. The mirror 50 only needs to reflect part of the display light DL, and examples of the mirror 50 also include a light transmissive member such as a half-silvered mirror or a glass plate. Specifically, the mirror 50 is a film-shaped member attached to the inner surface of a windshield 12, and has the function of a half-silvered mirror, which transmits part of incident light and reflects part of the light. The mirror 50 is disposed above the video projector 500 so as to face the video projector 500. The transmittance of the mirror 50 is set, for example, to 75%, but is not limited thereto. Note that the mirror 50 may be the windshield 12 as it is but having the function of a half-silvered mirror. When the mirror 50 is a light transmissive member, the rear side of the windshield 12, that is, the side opposite the driver DR may be painted black to the extent that the painted portion does not block the field of view. The reflectance of the mirror 50 thus becomes approximately 100%, so that the display light DL can be observed more clearly.

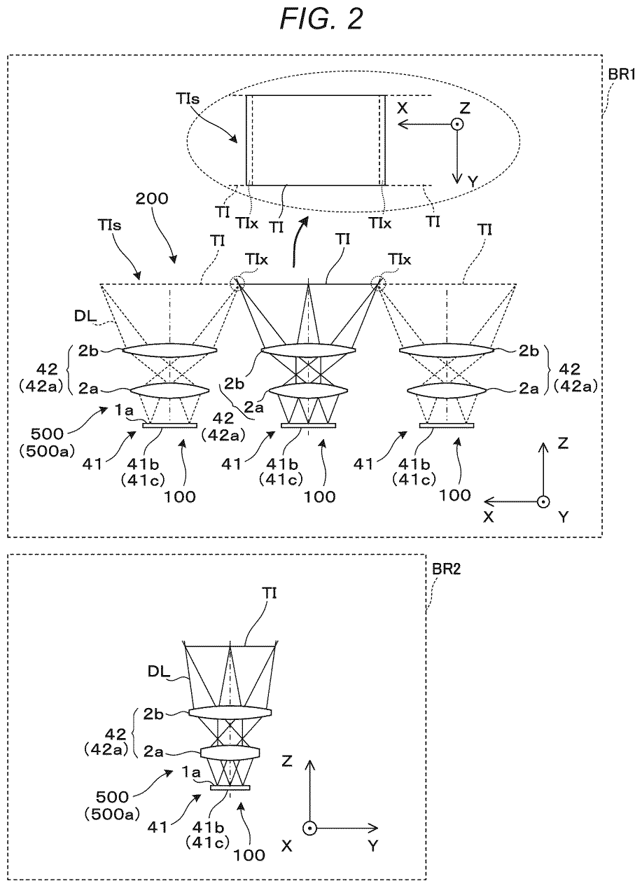

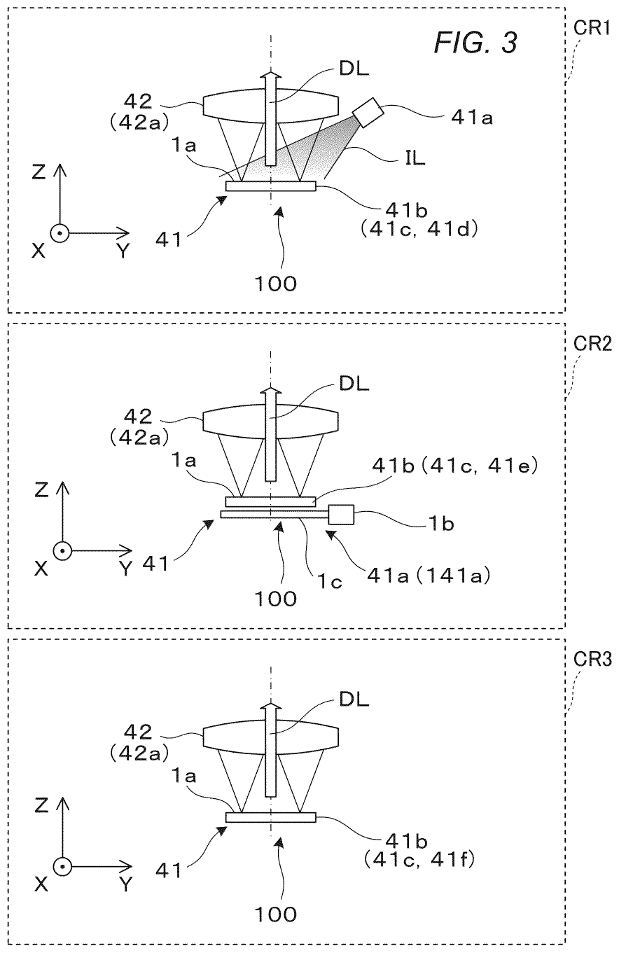

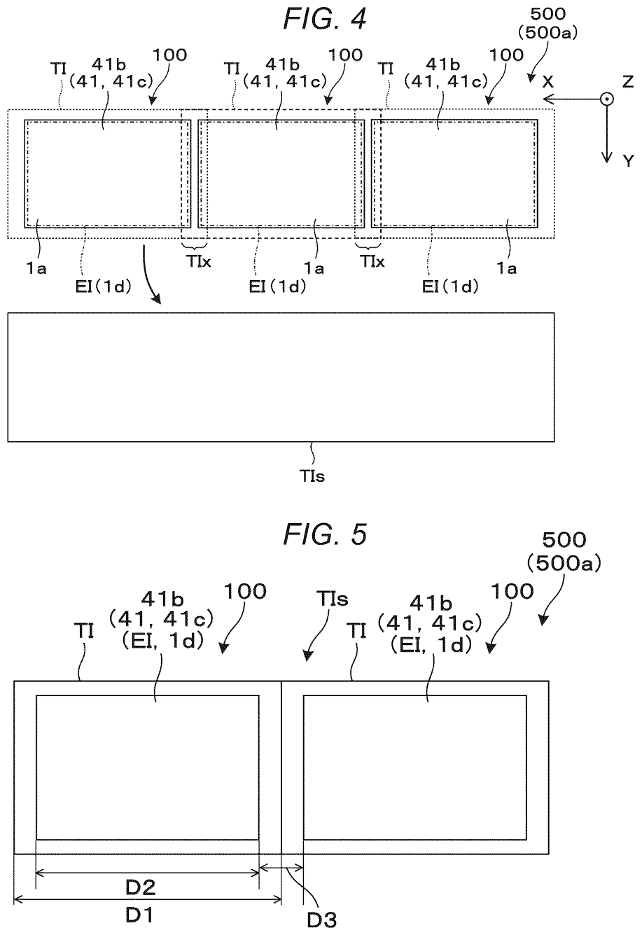

FIG. 2 is a conceptual view illustrating the video projector 500. A region BR1 in FIG. 2 shows the video projector 500 viewed from the front, that is, in the +Y direction. A region BR2 in FIG. 2 shows the video projector 500 viewed from one side, that is, in the +X direction. FIG. 3 illustrates each image generator 41 of the video projector 500. FIG. 4 illustrates display elements 41b of the image generators 41, intermediate images TI, and an overlapped intermediate image TIs.

As shown in a region BR1 in FIG. 2, the video projector 500 includes two or more display apparatuses 100 and a display controller 80 (see FIG. 1). That is, the video projector 500 includes multiple display apparatuses 100. In the video projector 500, the entire optical system of the multiple display apparatuses 100 is referred to as a display optical system 500a. The video projector 500 causes the multiple display apparatuses 100 to form multiple intermediate images TI, and forms the overlapped intermediate image TIs by overlapping the intermediate images TI each other. The mirror 50 shown in FIG. 1 reflects the display light DL from the overlapped intermediate image TIs off a horizontally elongated reflection region 50a of the mirror 50 extending in the X direction so that the reflected display light DL is visually recognized as a virtual image by the observer US. As a result, the virtual image becomes a horizontally elongated video having a large aspect ratio. The head-up display apparatus 200 can thus realize wide-screen display. In the present embodiment, a boundary portion between the intermediate images TI is filled with intermediate images TI enlarged from the images at the display elements 41b. The display controller 80 performs image processing on an overlapped portion TIx, where intermediate images TI overlap with each other, so that a single continuous wide-screen video or image can be displayed.

The display apparatuses 100 each emit the display light DL, as shown in FIGS. 2 and 3. The display apparatuses 100 each include an image generator 41, which generates a video or an image, and a projection optical element 42, which forms the intermediate image TI. The display apparatuses 100 are so arranged that portions of the intermediate images TI overlap with each other to form the single overlapped intermediate image TIs.

The image generator 41 includes a light source apparatus 41a and the display element 41b, as shown in a region CR1 in FIG. 3. The display element 41b forms a video or an image at a two-dimensional display surface 1a. The display element 41b has a display region 1d, where an effective image EI of the video or the image is formed, as shown in FIG. 4. The effective image EI is an image that can ensure the optical performance of the original video or image. In the region CR1 in FIG. 3, the display element 41b is a light modulator 41c, which forms the display light DL, specifically, a reflective modulator 41d. The reflective modulator 41d modulates the light from the light source apparatus 41a in accordance with a video signal from the display controller 80 shown in FIG. 1. The reflective modulator 41d, which can block and unblock the light, can significantly increase the contrast of the resultant video or image, and can therefore significantly improve the visibility of a virtual image displayed by the head-up display apparatus 200 as an in-vehicle display. The effects of providing appropriate information and reducing the stress on the observer US can thus be further improved. Examples of the reflective modulator 41d may include a digital mirror device (DMD) and a liquid-crystal-on-silicon (LCOS) device. The light source apparatus 41a can, for example, be a lamp, a light emitting diode (LED), or a semiconductor laser.

Note that the image generator 41 may include other elements. Regions CR2 and CR3 in FIG. 3 illustrate variations of the image generator 41.

The image generator 41 includes the light source apparatus 41a and the display element 41b, as shown in the region CR2 in FIG. 3. The display element 41b shown in the region CR2 in FIG. 3 is the light modulator 41c, and is specifically a transmissive modulator 41e. The transmissive modulator 41e modulates the light from the light source apparatus 41a in accordance with the video signal from the display controller 80 shown in FIG. 1. Since the transmissive modulator 41e can shorten the optical path of the light from the light source apparatus 41a, which irradiates the transmissive modulator 41e with the light, the size of the display apparatus 100 can be reduced. In addition, for example, when a liquid crystal element or a liquid crystal panel is used as the transmissive modulator 41e, a display used for other applications can be used as it is, so that significant cost reduction can be expected. The transmissive modulator 41e may, for example, be a liquid crystal display (LCD). The light source apparatus 41a can, for example, be a backlight optical system such as a backlight or an illumination optical system such as a lamp, an LED, or a semiconductor laser. In the example shown in the region CR2 in FIG. 3, the light source apparatus 41a is a backlight 141a, which is configured with a light source 1b and a light guide plate 1c.

The image generator 41 includes the display element 41b, as shown in the region CR3 in FIG. 3. The display element 41b shown in the region CR3 in FIG. 3 is the light modulator 41c, and is specifically a self-luminous modulator 41f. Although not shown the self-luminous modulator 41f includes multiple light emitters. The light emitters each modulate the light therefrom in accordance with the video signal from the display controller 80 shown in FIG. 1. No illumination optical system that irradiates the display element 41b with light is thus necessary, the display apparatuses 100 and in turn the video projector 500 can be reduced in size. As a result, significant cost reduction can be expected. Examples of the self-luminous modulator 41f may include a micro LED and an organic light emitting diode (OLED).

The projection optical element 42 forms the intermediate image TI, as shown in FIG. 2. The projection optical element 42 is disposed between the image generator 41 and the mirror 50 (see FIG. 1). In the present embodiment, the projection optical element 42 is a relay optical element 42a. The relay optical element 42a includes one or more projection lenses 2a and 2b. The projection optical element 42 enlarges a video or an image formed at the display surface 1a of the display element 41b to form the intermediate image TI on the light exiting side. The intermediate image TI has a rectangular contour. The intermediate image TI is so enlarged that the size of the enlarged intermediate image TI is about 1.2 times the size of the display surface 1a of the display element 41b.

In the display optical system 500a of the video projector 500, three rectangular display elements 41b are arranged with a predetermined gap therebetween in the horizontal direction, that is, the X direction, as shown in FIG. 4. In contrast, the overlapped intermediate image TIs formed by the video projector 500 is configured with three rectangular intermediate images TI arranged in the horizontal direction, that is, the X direction with no gap therebetween. In the example shown in FIG. 4, adjacent intermediate images TI overlap with each other with the overlapped portion TIx therebetween. Instead, the ends of the adjacent intermediate images TI may be in contact with each other with no overlapped portion TIx therebetween.

The intermediate images TI are each larger than the effective image EI of the corresponding display element 41b. The size of each of the intermediate images TI can thus be set with a large degree of freedom, so that a sufficient range over which the intermediate images TI overlap with each other can be secured. The gap between the virtual images corresponding to the intermediate images TI can thus be reliably eliminated, so that the visibility of the virtual images can be significantly improved. As a result, the effects of providing appropriate information and reducing the stress on the observer US can be further improved. In addition, the display apparatuses 100 and in turn the video projector 500 can also be reduced in size, and a significant cost reduction can be expected.

As shown in FIG. 5, the display apparatuses 100 each satisfy the following expression:
D1−D2>D3,
   where D1: the width of each of the intermediate images TI in an arrangement direction WX of the display elements 41b or the light modulators 41c,
   D2: the width of each of the display elements 41b in the arrangement direction WX of the display elements 41b or the light modulators 41c, and
   D3: the gap between the effective images EI formed by the display elements 41b in the arrangement direction WX of the display elements 41b or the light modulators 41c.

The arrangement direction WX of the display elements 41b or the light modulators 41c is the direction in which the display elements 41b or the light modulators 41c are arranged. In other words, the arrangement direction WX of the display elements 41b or the light modulators 41c is the longitudinal direction (X direction) of the intermediate images TI, that is, the horizontal direction of the intermediate images TI.

When the expression described above is satisfied, the range over which the intermediate images TI overlap with each other can be sufficiently secured. The gap between the virtual images corresponding to the intermediate images TI can thus be reliably eliminated, so that the visibility of the virtual images can be significantly improved. As a result, the effects of providing appropriate information and reducing the stress on the observer US can be further improved.

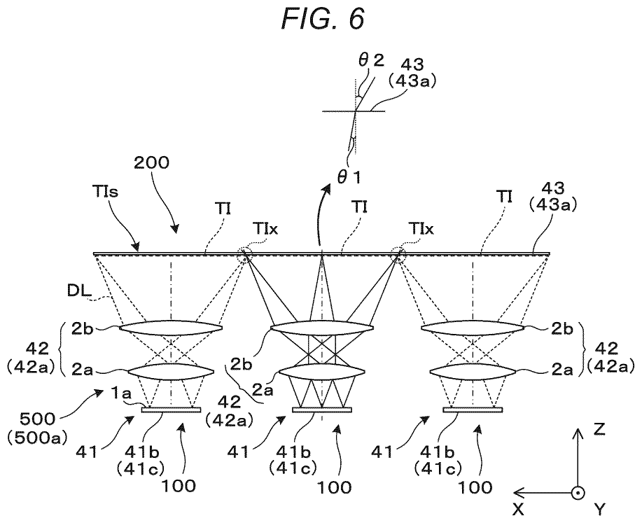

In the present embodiment, the video projector 500 or the display apparatuses 100 include a diffusing optical element 43 having a diffusion function at a position where the intermediate images TI are formed, as shown in FIG. 6. Specifically, the video projector 500 includes a diffusing screen 43a at a position where the intermediate images TI are formed, as shown in FIG. 6. In this case, the video projector 500 satisfies the following expression:
θ1<θ2
   where θ1: the angle of incidence of the light incident on the diffusing optical element 43 (angle of incidence of convergent light), and
   θ2: the angle of emergence of the light emerging from the diffusing optical element 43 (angle of emergence of divergent light).

The diffusion function provided at the position where the intermediate images TI are formed allows the angle of emergence θ2 to be greater than the angle of incidence θ1, so that a wide viewing angle can be secured. The visibility of the virtual images can thus be significantly improved, so that the effects of providing appropriate information and reducing the stress on the observer US can be further improved.

Note that the diffusing optical element 43 may be omitted as appropriate.

The display controller 80 shown FIG. 1 controls the operation of displaying a video displayed at the display surface 1a of each of the display elements 41b. The display controller 80 performs image processing in a way that the overlapped portions TIx (see FIG. 4, for example), where the intermediate images TI are overlapped each other, connect the intermediate images TI to each other into a continuous video. The image processing may, for example, be blending. The blending can be performed, for example, by using the technology disclosed in JP-A-11-098439.

The optical path and the like of the head-up display apparatus 200 shown in FIG. 1 will be described below. In the video projector 500, the display light DL from a video or an image formed at the display surface 1a (see FIG. 2, for example) of the display element 41b of each of the display apparatuses 100 travels via the projection optical element 42, is partially reflected off the mirror 50, and enters each pupil PU of the observer US or the driver DR. That is, the driver DR can observe the display light DL reflected off the mirror 50, that is, a displayed image DI as a virtual image in front of the automobile 10. In this process, the video projector 500 causes the multiple display apparatuses 100 to form the intermediate images TI, and overlaps the multiple intermediate images TI each other to form the overlapped intermediate image TIs. The displayed image DI therefore becomes a horizontally elongated wide-screen image corresponding to the overlapped intermediate image TIs.

The driver DR can further observe external light having passed through the mirror 50, that is, real images of objects present in front of the driver DR. As a result, the driver DR can observe the displayed image (virtual image) DI formed by the display light DL reflected off the mirror 50 and containing various pieces of information such as driving-related information, with the displayed image DI overlapping with an external image or a see-through image behind the windshield 12, as an image behind a steering wheel 14 or the windshield 12.

The head-up display apparatus 200 described above includes the two or more display apparatuses 100, which each output the display light DL, and the mirror 50, which reflects the display light DL emitted from each of the display apparatuses 100, the display apparatuses 100 each including the image generator 41, which generates a video, the projection optical element 42, which forms the intermediate image TI corresponding to the video, and the display controller 80, which controls the operation of displaying the video, the intermediate images TI formed by the display apparatuses 100 being so disposed that portions of the intermediate images TI overlap with each other so that the single overlapped intermediate image TIs is created, the display controller 80 performing image processing on the overlapping portions TIx, where the intermediate images TI overlap with each other, in a way that a continuous video is created, and the mirror 50 reflecting the display light DL from the overlapped intermediate image TIs so as to be visually recognized as a virtual image by the observer US.

The head-up display apparatus 200 described above, which displays a horizontally elongated wide-screen image in the form of a virtual image resulting from the overlapped intermediate image TIs, into which the multiple intermediate images TI are connected to each other, allows reduction in the size and cost of the entire apparatus as compared with a configuration in which one display apparatus 100 displays a virtual image. Furthermore, forming the overlapped intermediate image TIs makes the boundary corresponding to the gap between adjacent display apparatuses 100 invisible in the region where the virtual images are displayed, so that a continuous wide-screen image can be provided. Therefore, when a map or a video extending over multiple display regions is displayed, necessary information is not lost or an unnatural video is not displayed in the boundary portions. Therefore, appropriate information can be provided, and the stress on the observer US can be reduced. In addition, it is not necessary to produce a boundary-avoiding video content or design a boundary-avoiding display layout, so that the simplification of content creation allows cost reduction, and free design and expression.

The vehicle 300 described above includes the head-up display apparatus 200 described above. The vehicle 300 including the head-up display apparatus 200 reduced in size can thus be realized. The display apparatuses 100, which constitute the head-up display apparatus 200, can each include the versatile image generator 41 even when the vehicle 300 is equipped with the head-up display apparatus 200, so that the cost can be suppressed.

### Second Embodiment

A head-up display apparatus according to a second embodiment will be described below. Note that the head-up display apparatus according to the second embodiment is a partially modified version of the head-up display apparatus according to the first embodiment, and portions common to those of the head-up display apparatus according to the first embodiment will not be described.

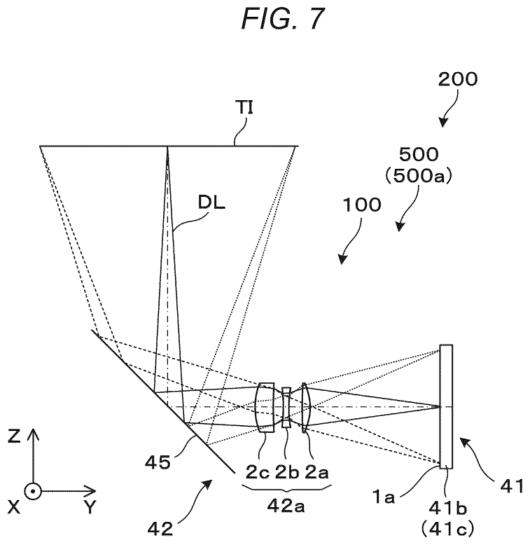

In the present embodiment, the relay optical elements 42a, which are the projection optical elements 42, each include multiple projection lenses 2a, 2b, and 2c, which adjust the size of the intermediate image TI, as shown in FIG. 7. Specifically, the relay optical element 42a includes the three projection lenses 2a, 2b, and 2c and a deflection mirror 45. The deflection mirror 45 is disposed between the enlargement-side projection lens 2c and the intermediate image TI.

In the head-up display apparatus 200 according to the present embodiment, since the projection optical elements 42 each include the multiple projection lenses 2a, 2b, and 2c, magnification and focus adjustment can be readily performed, and the size of the intermediate images TI can be set with a large degree of freedom, so that the range over which the intermediate images TI overlap with each other can be sufficiently secured. The gap between the virtual images corresponding to the intermediate images TI can thus be reliably eliminated, so that the visibility of the virtual images can be significantly improved. As a result, the effects of providing appropriate information and reducing the stress on the observer US can be further improved.

### Third Embodiment

A head-up display apparatus according to a third embodiment will be described below. Note that the head-up display apparatus according to the third embodiment is a partially modified version of the head-up display apparatus according to the first embodiment, and portions common to those of the head-up display apparatus according to the first embodiment will not be described.

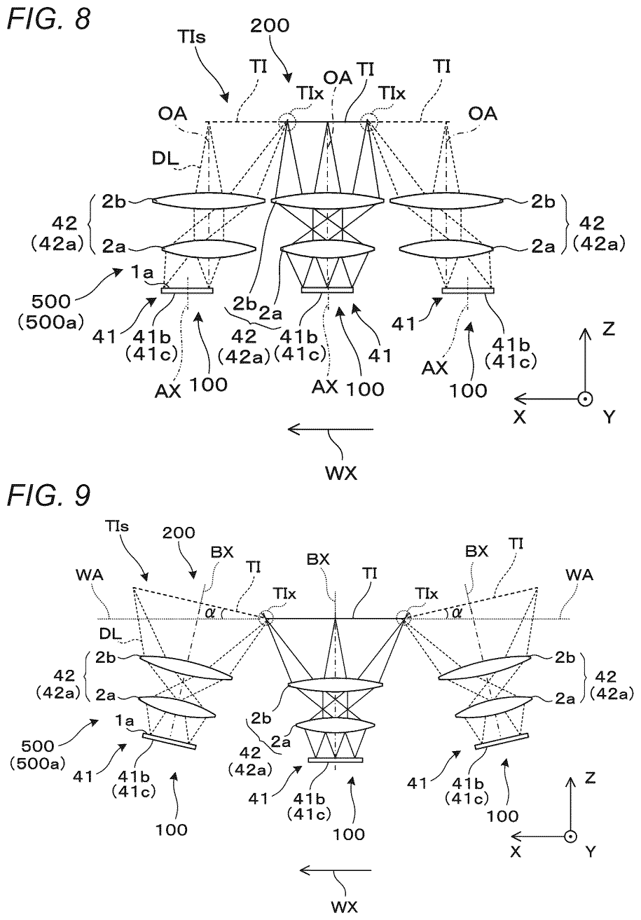

In the present embodiment, the overlapped intermediate image TIs is formed by shifting adjacent intermediate images TI so as to approach each other to fill the boundary portion between the intermediate images TI, as shown in FIG. 8.

In the video projector 500, at least one of the multiple display apparatuses 100 is so configured that a center axis AX of the light modulator 41c, which is the display element 41b, is shifted in the arrangement direction WX, in which the light modulators 41c are arranged, from an optical axis OA of the projection optical element 42 to overlap the intermediate images TI each other. The display apparatuses 100 adjacent to each other therefore differ from each other in the amount by which the center axis AX of the display element 41b or the light modulator 41c is shifted or the direction in which the center axis AX is shifted.

In the head-up display apparatus 200 according to the present embodiment, since the positions of the intermediate images TI can be set with a large degree of freedom, a sufficient range over which the intermediate images TI overlap with each other can be secured. The gap between the virtual images corresponding to the intermediate images TI can thus be reliably eliminated, so that the visibility of the virtual images can be significantly improved. As a result, the effects of providing appropriate information and reducing the stress on the observer US can be further improved.

### Fourth Embodiment

A head-up display apparatus according to a fourth embodiment will be described below. Note that the head-up display apparatus according to the fourth embodiment is a partially modified version of the head-up display apparatus according to the first embodiment, and portions common to those of the head-up display apparatus according to the first embodiment will not be described.

In the present embodiment, the overlapped intermediate image TIs is formed by inclining one or more intermediate images TI to fill the boundary portion between the intermediate images TI, as shown in FIG. 9.

Specifically, adjacent intermediate images TI are inclined by different angles with respect to a wide axis WA parallel to the arrangement direction WX, in which the light modulators 41c are arranged. In other words, center axes BX of the intermediate images TI incline by different amounts. The wide axis WA is an axis extending in the longitudinal direction or the horizontal direction of a reference intermediate image TI out of the multiple intermediate images TI, that is, in the X direction. The angle by which each of the intermediate images TI is inclined is an angle that maintains the depth of field.

In the example shown in FIG. 9, out of the three intermediate images TI, the middle intermediate image TI serving as the reference is not inclined, the left intermediate image TI is inclined by an angle α clockwise with respect to the wide axis WA, and the right intermediate image TI is inclined by the angle α counterclockwise with respect to the wide axis WA. The overlapped intermediate image TIs formed by the video projector 500 is slightly warped, but the virtual image visually recognized via the mirror 50 is a substantially planar image.

The range over which the intermediate images TI overlap with each other can be sufficiently secured as long as the angle of each of the intermediate images TI can be appropriately set. The gap between the virtual images corresponding to the intermediate images TI can thus be reliably eliminated, so that the visibility of the virtual images can be significantly improved. As a result, the effects of providing appropriate information and reducing the stress on the observer US can be further improved.

### Fifth Embodiment

A head-up display apparatus according to a fifth embodiment will be described below. Note that the head-up display apparatus according to the fifth embodiment is a partially modified version of the head-up display apparatus according to the first embodiment, and portions common to those of the head-up display apparatus according to the first embodiment will not be described.

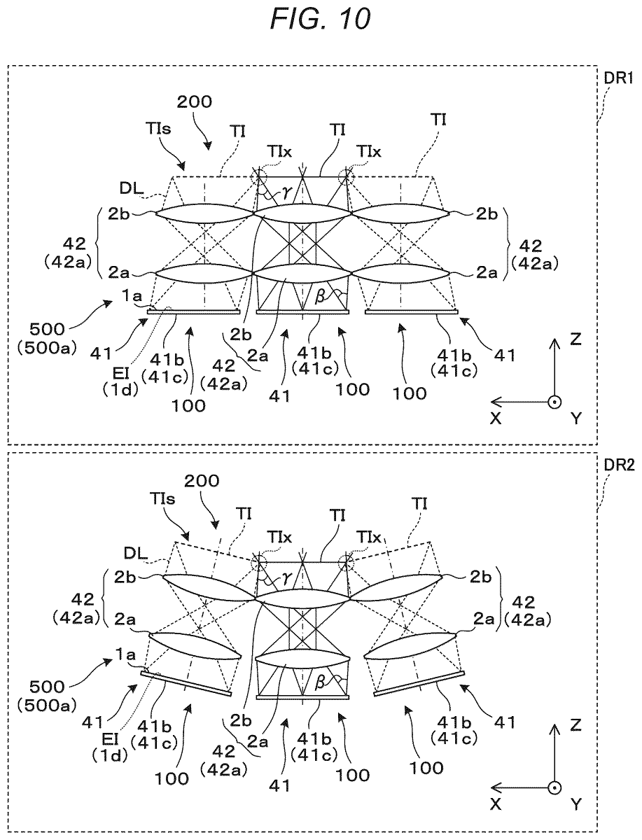

In the present embodiment, the size of the intermediate image TI formed by each of the display apparatuses 100 is equal to the size of the effective image EI formed by or the display region 1d of the display element 41b of the image generator 41, as shown in regions DR1 and DR2 in FIG. 10. That is, when the intermediate image TI and the effective image EI are compared with each other, the effective image EI, which is the original image, is projected by a factor of one as the intermediate image TI. Furthermore, a spread angle β of the divergent light emitted from the display element 41b and a spread angle γ of the convergent light incident on the position of the intermediate image TI are the same or substantially the same.

In the head-up display apparatus 200 according to the present embodiment, since the size of the effective image EI formed by the display element 41b and the size of the intermediate image TI are the same, the spread angle of the light can be maintained, so that a wide viewing angle can be secured. In addition, since the viewing angle can be secured without adding the diffusion effect of increasing the viewing angle after the intermediate image TI is formed, loss of brightness is also small. The visibility of the virtual images can therefore be significantly improved, so that the effects of providing appropriate information and reducing the stress on the observer US can thus be further improved.

When the size of the effective images EI formed by the display elements 41b and the size of the intermediate images TI are the same, the method of shifting the display elements 41b or the light modulators 41c as shown in a region DR1 in FIG. 10 or the method of inclining the intermediate images TI as shown in a region DR2 in FIG. 10 is used as the method of overlapping the intermediate images TI each other.

Note in the present embodiment that no diffusion member or the like may be provided, but the diffusing optical element 43 shown in FIG. 6 may be provided.

### Sixth Embodiment

A head-up display apparatus according to a sixth embodiment will be described below. Note that the head-up display apparatus according to the sixth embodiment is a partially modified version of the head-up display apparatus according to the first embodiment, and portions common to those of the head-up display apparatus according to the first embodiment will not be described.

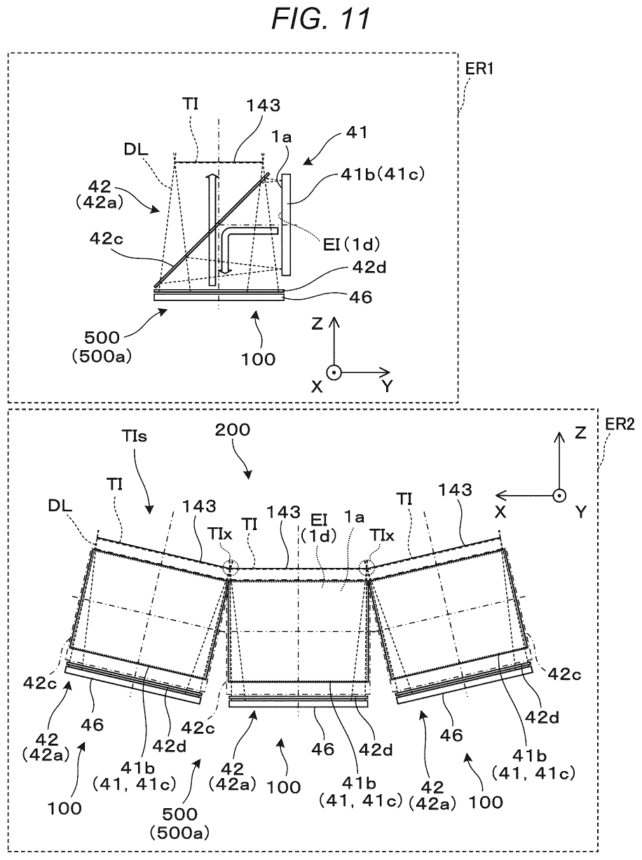

In the present embodiment, the video projector 500 causes the intermediate images TI to be overlapped each other via an optical system including a retroreflector 46 to achieve a horizontally-elongated-screen or wide-screen virtual image, as shown in regions ER1 and ER2 in FIG. 11. In the present embodiment, the size of the intermediate image TI formed by each of the display apparatuses 100 of the video projector 500 is equal to the size of the effective image EI formed by or the display region 1d of the display element 41b of the image generator 41. The video projector 500 or the display apparatuses 100 include a transmissive diffusion member 143 at the position where the intermediate images TI are formed. The transmissive diffusion member 143 is a light transmissive member containing a diffusing material. The transmissive diffusion member 143 may be the same as the diffusing optical element 43 (diffusing screen 43a) shown in FIG. 6. Providing the transmissive diffusion member 143 prevents the boundary portions from being shifted depending on the angle at which the observer US views the virtual images.

In each of the display apparatuses 100, the projection optical element 42 includes a polarizing beam splitter 42c, a quarter-wave plate 42d, and the retroreflector 46 as the relay optical element 42a. The retroreflector 46 includes an aggregate of corner cubes that are not shown but reflect light having entered the retroreflector 46 in a direction parallel to and opposite the light incident direction. In the present embodiment, the image generator 41 outputs predetermined polarized light. Specifically, a polarizer or the like that transmits the predetermined polarized light, for example, S-polarized light, is provided on the light exiting side of the display element 41b. In this case, the polarizing beam splitter 42c is designed to reflect S-polarized light and transmit P-polarized light. Note that the polarization characteristics of the polarizing beam splitter 42c can be changed as appropriate in accordance with the polarized light emitted from the image generator 41.

The image generator 41 outputs the predetermined polarized light, for example, S-polarized light, as the display light DL and irradiates the polarizing beam splitter 42c with the display light DL. The display light DL with which the polarizing beam splitter 42c is irradiated is reflected off the polarizing beam splitter 42c and travels toward the quarter-wave plate 42d. The S-polarized display light DL passes through the quarter-wave plate 42d, which converts the display light DL into circularly polarized light. Thereafter, the light output by the retroreflector 46 at an angle equal to the angle of incidence passes through the quarter-wave plate 42d again, which converts the light into P-polarized light. The P-polarized light passes through the polarizing beam splitter 42c, forms an image conjugate with the display element 41b, that is, the intermediate image TI on the transmissive diffusion member 143, and becomes diffused light when passing through the transmissive diffusion member 143. The multiple intermediate images TI are thus overlapped each other to form the overlapped intermediate image TIs.

As described above, in the head-up display apparatus 200 according to the present embodiment, since the display elements 41b are invisible on a physical extension of the optical path of the apparatus when the observer US views the intermediate images TI, stray light or ghost light is not directly visible from the display elements 41b without via the intermediate images TI, so that a high-quality video can be displayed. The visibility of the virtual images can therefore be significantly improved, so that the effects of providing appropriate information and reducing the stress on the observer US can thus be further improved.

### Seventh Embodiment

A head-up display apparatus according to a seventh embodiment will be described below. Note that the head-up display apparatus according to the seventh embodiment is a partially modified version of the head-up display apparatus according to the first embodiment, and portions common to those of the head-up display apparatus according to the first embodiment will not be described.

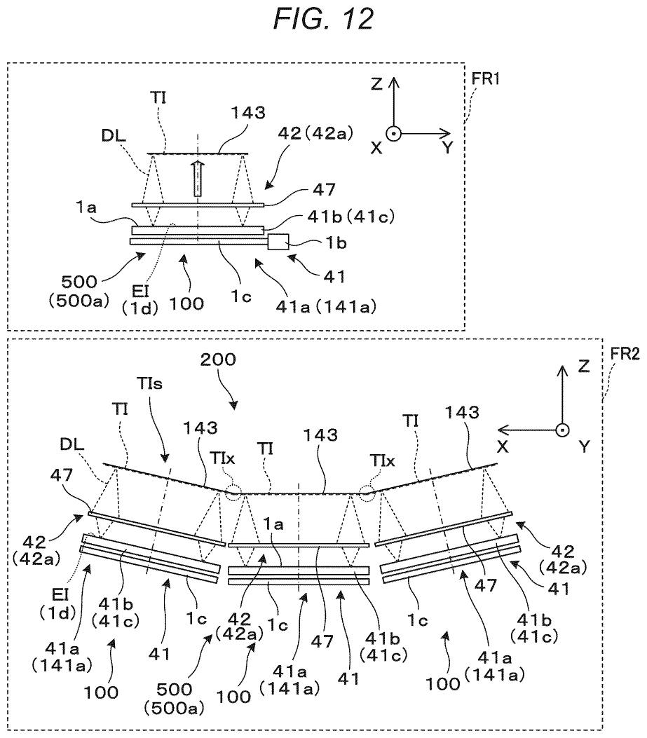

In the present embodiment, the video projector 500 causes the intermediate images TI to be overlapped each other via an optical system including a plane-symmetric imaging optical element 47 to achieve a horizontally-elongated-screen or wide-screen virtual image, as shown in regions FR1 and FR2 in FIG. 12. In the present embodiment, the size of the intermediate image TI formed by each of the display apparatuses 100 of the video projector 500 is equal to the size of the effective image EI formed by or the display region 1d of the display element 41b of the image generator 41. The video projector 500 includes the transmissive diffusion member 143 at the position where the intermediate images TI are formed. The transmissive diffusion member 143 may be the same as the diffusing optical element 43 (diffusing screen 43a) shown in FIG. 6. Providing the transmissive diffusion member 143 prevents the boundary portions from being shifted depending on the angle at which the observer US views the virtual images.

In each of the display apparatuses 100, the projection optical element 42 includes the plane-symmetric imaging optical element 47 as the relay optical element 42a. The plane-symmetric imaging optical element 47 brings the light from the image generator 41 into focus at the transmissive diffusion member 143 in a plane symmetric manner with the plane-symmetric imaging optical element 47 interposed between the image generator 41 and the transmissive diffusion member 143.

In the head-up display apparatus 200 according to the present embodiment, the distance between the intermediate images TI and the image generators 41, specifically, the display elements 41b can be minimized, so that a very compact structure is achieved, and significant cost reduction can be expected.

The plane-symmetric imaging optical element 47 is, for example, of the following three types.

### (1) Single-MLA-Type Plane-Symmetric Imaging Optical Element

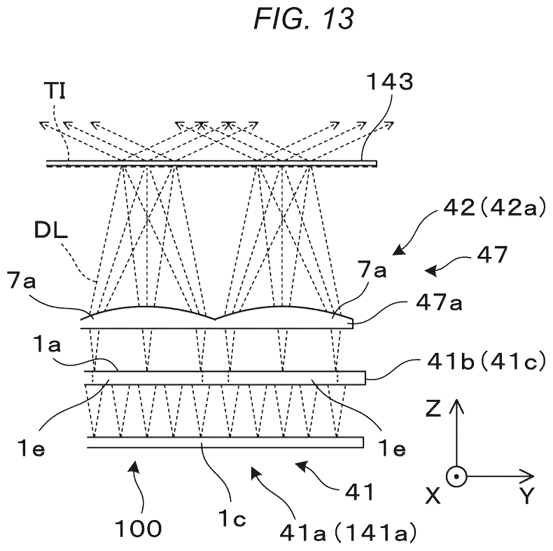

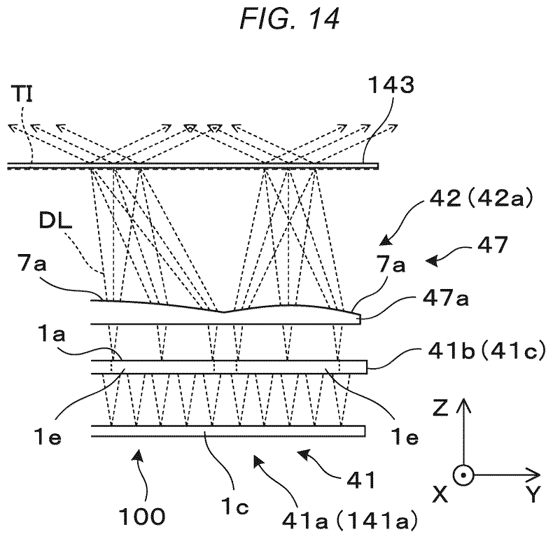

In each of the display apparatuses 100, the projection optical element 42 includes a microlens array 47a as the plane-symmetric imaging optical element 47, as shown in FIG. 13. In the microlens array 47a, microlenses 7a are arranged at positions corresponding to pixels 1e of the display element 41b.

The light emitted from the light source apparatus 41a, specifically, the backlight 141a and having a narrow spread angle is radiated to the pixels 1e of the display element 41b. The pixels 1e of the display element 41b, which is configured, for example, with a liquid crystal material, can each block and unblock incident light. Although not shown, when the display element 41b is a liquid crystal element or a liquid crystal panel, polarizers disposed in a crossed Nicol arrangement are provided on the light incident side and the light exiting side of the display element 41b.

The light emitted from each of the pixels 1e is incident on the microlens array 47a in correspondence with the pixel 1e. The light is incident on the microlens array 47a with the narrow spread angle of the light from the backlight 141a unchanged. The transmissive diffusion member 143 is disposed at the position separate from the microlens array 47a by the focal length thereof. The position separate from the microlens array 47a by the focal length thereof is the position where the luminous flux emitted from the microlens array 47a is collected to a smallest spot. The transmissive diffusion member 143 converts the light still having the narrow spread angle into diffused light. The observer US can recognize the image of the surface of the transmissive diffusion member 143, that is, the intermediate image TI as an image conjugate with the image formed by the display element 41b.

In the single-MLA-type plane-symmetric imaging optical element 47, the intermediate image TI can be produced with the simple configuration (in which microlens array 47a is disposed on light exiting side of display element 41b). The video projector 500 can therefore be a thin unit, so that the distance between the intermediate images TI and the image generators 41 can be minimized. As described above, the head-up display apparatus 200 has a very compact structure, so that a significant cost reduction can be expected.

In each of the display apparatuses 100, the single-MLA-type plane-symmetric imaging optical element 47 can be used in an enlargement projection system that enlarges the intermediate image TI with respect to the display element 41b, as shown in FIG. 14. Specifically, the microlens array 47a enlarges the intermediate image TI with the size of the microlenses 7a changed or the positions of the microlenses 7a shifted.

### (2) Double-MLA-Type Plane-Symmetric Imaging Optical Element

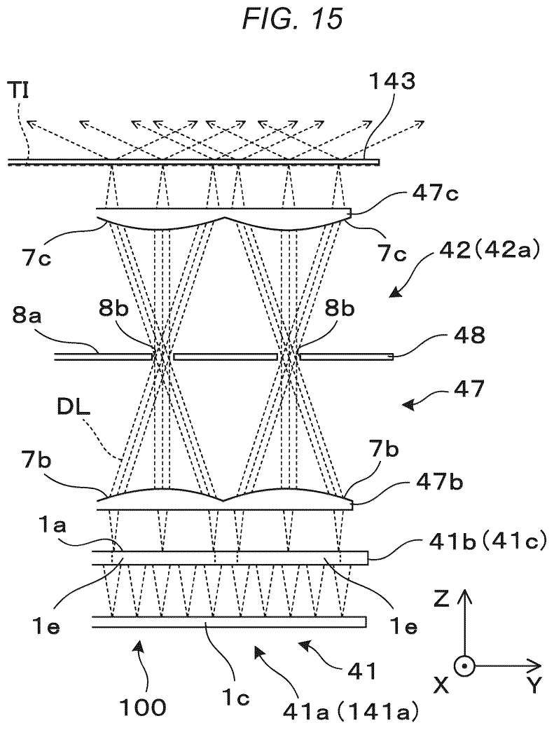

In each of the display apparatuses 100, the projection optical element 42 includes a light-incident-side microlens array 47b, a diaphragm 48, and a light-exiting-side microlens array 47c as the plane-symmetric imaging optical element 47, as shown in FIG. 15. In the light-incident-side microlens array 47b and the light-exiting-side microlens array 47c, microlenses 7b and 7c are arranged at positions corresponding to the pixels 1e of the display element 41b. The diaphragm 48 is a light blocker 8a provided with multiple openings 8b. The openings 8b are disposed at positions corresponding to the pixels 1e of the display element 41b.

The light emitted from the light source apparatus 41a, specifically, the backlight 141a and having a narrow spread angle is radiated to the pixels 1e of the display element 41b. The pixels 1e of the display element 41b, which is configured, for example, with a liquid crystal material, can each block and unblock incident light. Although not shown, when the display element 41b is a liquid crystal element or a liquid crystal panel, polarizers disposed in a crossed Nicol arrangement are provided on the light incident side and the light exiting side of the display element 41b.

The light emitted from each of the pixels 1e is incident on the light-incident-side microlens array 47b in correspondence with the pixel 1e. The light is incident on the light-incident-side microlens array 47b with the narrow spread angle of the light from the backlight 141a unchanged. The diaphragm 48 is disposed at the position separate from the light-incident-side microlens array 47b by the focal length thereof. The diaphragm 48 prevents stray light generated, for example, at the pixels 1e. The light having passes through the diaphragm 48 and hence having spread passes through the light-exiting-side microlens array 47c, which collimates and collects the light to form images conjugate with the pixels 1e. The transmissive diffusion member 143 disposed at the position where the conjugate images are formed converts the light having the narrow spread angle into diffused light. The observer US can recognize the image of the surface of the transmissive diffusion member 143, that is, the intermediate image TI as an image conjugate with the image formed by the display element 41b.

The double-MLA-type plane-symmetric imaging optical element 47, in which stray light and ghost light can be blocked by the diaphragm 48, can realize a high-contrast image. The visibility of the virtual images can thus be significantly improved, so that the effects of providing appropriate information and reducing the stress on the driver can thus be further improved.

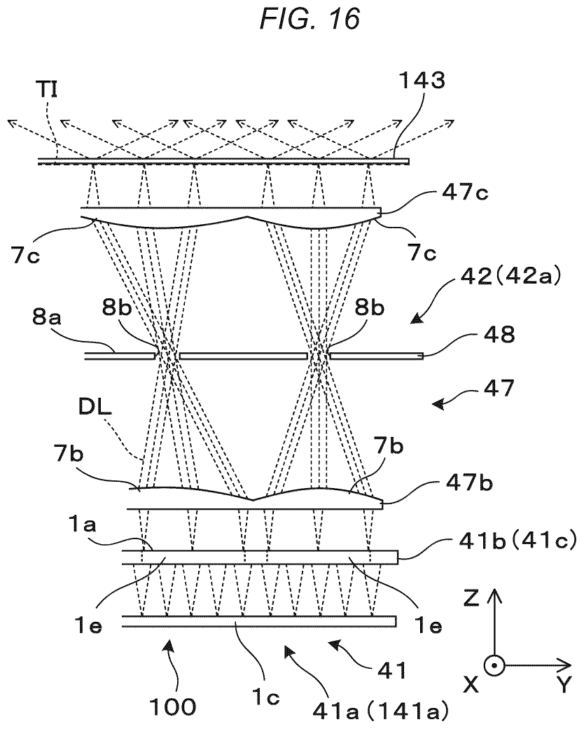

In each of the display apparatuses 100, the double-MLA-type plane-symmetric imaging optical element 47 can be used in an enlargement projection system that enlarges the intermediate image TI with respect to the display element 41b, as shown in FIG. 16. Specifically, the microlens arrays 47b and 47c enlarge the intermediate image TI with the size of the microlenseses 7b and 7c changed or the positions of the microlenseses 7b and 7c shifted.

### (3) Micromirror-Type Plane-Symmetric Imaging Optical Element

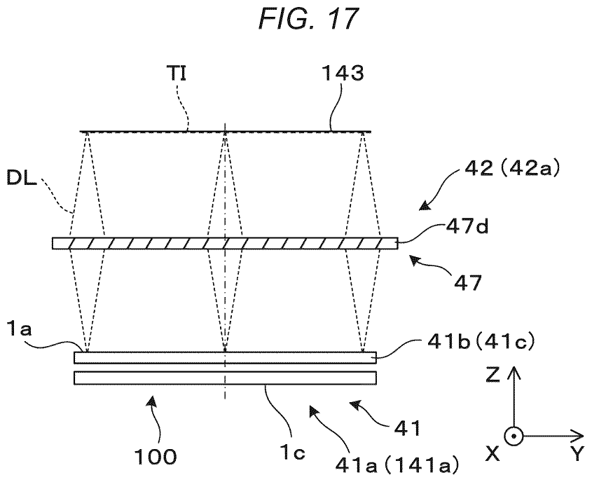

In each of the display apparatuses 100, the projection optical element 42 includes a mirror array element 47d as the plane-symmetric imaging optical element 47, as shown in FIG. 17. The mirror array element 47d includes multiple micromirrors that are not shown. Examples of the micromirrors may include dihedral corner reflectors and dihedral orthogonal reflectors. The light incident on the mirror array element 47d is reflected twice off the micromirrors and emit. The micromirror-type plane-symmetric imaging optical element 47 can be specifically produced, for example, by using the technology disclosed in JP-A-2021-139932.

The light from the display element 41b forms the intermediate image TI at the transmissive diffusion member 143 in a plane-symmetric manner with the mirror array element 47d interposed between the display element 41b and the transmissive diffusion member 143. The transmissive diffusion member 143 is disposed at the position where the intermediate image TI is formed.

In the micromirror-type plane-symmetric imaging optical element 47, the intermediate image TI can be produced with the simple configuration (in which mirror array element 47d is disposed on light exiting side of display element 41b). The video projector 500 can therefore be a thin unit, so that the distance between the intermediate images TI and the image generators 41 can be minimized.

### Other Items

The structures described above are presented by way of example, and can be changed in various manners to the extent that the same functions can be achieved.

The optical system of each of the display apparatuses 100 is merely an example, and the optical configuration can be changed as appropriate. The configurations of the image generator 41 and the projection optical element 42 can be changed as appropriate.

The projection optical element 42 may include concave mirrors in place of the projection lenses 2a, 2b, and 2c.

The number of the display apparatuses 100, which constitute the video projector 500, is not limited to three, and may be two or four or more.

The video projector 500 may not always form the overlapped intermediate image TIs. The video projector 500 may project an image that is a combination of the overlapped intermediate image TIs and intermediate images TI that are not overlapped on each other onto the mirror 50. For example, the overlapped intermediate image TIs or the intermediate images TI to be displayed as the virtual image may be switched from one to the other as appropriate by changing the size of the video displayed at the display surface 1a of each of the display elements 41b or moving or changing the elements of each of the display apparatuses 100.

The observer US is not limited to the driver DR, and may be another passenger sitting on a passenger seat, a backseat, or the like.

The mirror 50 may be an independent element installed separately from the windshield 12.

The head-up display apparatus 200 is not necessarily incorporated in the vehicle 300, and can be used for other applications as long as the head-up display apparatus 200 displays a video formed by the display elements 41b in the form of a virtual image.

### Summary of Present Disclosure

The present disclosure will be summarized below in the form of additional remarks.

### Additional Remark 1

A head-up display apparatus including:
two or more display apparatuses each configured to emit display light; and
a mirror configured to reflect the display light emitted from each of the display apparatuses,
in which the display apparatuses each include an image generator configured to generate a video, a projection optical element configured to form an intermediate image corresponding to the video, and a display controller configured to control operation of displaying the video, t
he intermediate images formed by the display apparatuses are so disposed that portions of the intermediate images overlap with each other so that a single overlapped intermediate image is created,
the display controller is configured to perform image processing on overlapping portions where the intermediate images overlap with each other in a way that a continuous video is created, and
the mirror is configured to reflect the display light from the overlapped intermediate image so as to be visually recognized as a virtual image by an observer.

Displaying a horizontally elongated wide-screen image in the form of a virtual image resulting from the overlapped intermediate image, into which the multiple intermediate images are connected to each other, allows reduction in the size and cost of the entire apparatus as compared with a configuration in which one display apparatus displays a virtual image. Furthermore, forming the overlapped intermediate image makes the boundary corresponding to the gap between adjacent display apparatuses invisible in the region where the virtual images are displayed, so that a continuous wide-screen image can be provided. Therefore, when a map or a video extending over multiple display regions is displayed, necessary information is not lost or an unnatural video is not displayed in the boundary portions. Therefore, appropriate information can be provided, and the stress on the observer can be reduced. In addition, it is not necessary to produce a boundary-portion-avoiding video content or design a boundary-portion-avoiding display layout, so that the simplification of content creation allows cost reduction, and free design and expression.

### Additional Remark 2

The head-up display apparatus according to Additional Remark 1, in which
the image generators each include a reflective modulator as a light modulator configured to form the display light.

The reflective modulator, which can block and unblock the light, can significantly increase the contrast of the resultant video, and can therefore significantly improve the visibility of the virtual image. The effects of providing appropriate information and reducing the stress on the observer can thus be further improved.

### Additional Remark 3

The head-up display apparatus according to Additional Remark 1, in which
the image generators each include a transmissive modulator as a light modulator configured to form the display light.

Since the transmissive modulator can shorten the optical path of the light with which the transmissive modulator is irradiated, the size of each of the display apparatuses can be reduced. In addition, for example, when a liquid crystal element is used as the transmissive modulator, a general-purpose display or the like can be used as it is, so that significant cost reduction can be expected.

### Additional Remark 4

The head-up display apparatus according to Additional Remark 1, in which
the image generators each include multiple light emitters as a light modulator configured to form the display light.

The configuration described above eliminates the need for an illumination optical system in each of the image generators, so that the size of each of the display apparatuses can be reduced. As a result, significant cost reduction can be expected.

### Additional Remark 5

The head-up display apparatus according to any one of Additional Remarks 2 to 4,
in which a size of the intermediate image is greater than a size of an effective image formed by the light modulator.

In this case, the size of each of the intermediate images can be set with a large degree of freedom, so that a sufficient range over which the intermediate images overlap with each other can be secured. The gap between the virtual images corresponding to the intermediate images can thus be reliably eliminated, so that the visibility of the virtual images can be significantly improved. As a result, the effects of providing appropriate information and reducing the stress on the observer can be further improved. In addition, the display apparatuses can be reduced in size, and a significant cost reduction can be expected.

### Additional Remark 6

The head-up display apparatus according to any one of Additional Remarks 2 to 4,
in which a size of the intermediate image is equal to a size of an effective image formed by the light modulator.

In this case, since the size of the effective image formed by each of the light modulators and the size of the intermediate image are the same, the spread angle of the light can be maintained, so that a wide viewing angle can be secured. In addition, since the viewing angle can be secured without adding the diffusion effect of increasing the viewing angle after the intermediate images are formed, loss of brightness can be made small. The visibility of the virtual images can thus be significantly improved, so that the effects of providing appropriate information and reducing the stress on the observer can be further improved.

### Additional Remark 7

The head-up display apparatus according to any one of Additional Remarks 1 to 6,
in which the projection optical elements each include multiple projection lenses configured to adjust a size of the intermediate image.

In this case, magnification and focus adjustment can be readily performed, and the size of each of the intermediate images can therefore be set with a large degree of freedom, so that a sufficient range over which the intermediate images overlap with each other can be secured. The gap between the virtual images corresponding to the intermediate images can thus be reliably eliminated, so that the visibility of the virtual images can be significantly improved. As a result, the effects of providing appropriate information and reducing the stress on the observer can be further improved.

### Additional Remark 8

The head-up display apparatus according to any one of Additional Remarks 1 to 6,
in which the projection optical elements each include a retroreflector.

In this case, since the image generators are invisible on a physical extension of the optical path of the head-up display apparatus when the observer views the intermediate images, stray light or ghost light is not directly visible from the image generators without via the intermediate images, so that a high-quality video can be displayed. The visibility of the virtual images can thus be significantly improved, so that the effects of providing appropriate information and reducing the stress on the observer can be further improved.

### Additional Remark 9

The head-up display apparatus according to any one of Additional Remarks 1 to 6,
in which the projection optical elements each include a plane-symmetric imaging optical element.

In this case, the distance between the intermediate images and the image generators can be minimized, so that a very compact structure is achieved, and significant cost reduction can be expected.

### Additional Remark 10

The head-up display apparatus according to any one of Additional Remarks 1 to 7,
in which at least one of the multiple display apparatuses is so configured that a center axis of the light modulator is shifted in an arrangement direction of the light modulators from an optical axis of the projection optical element to overlap the intermediate images each other.

In this case, the position of each of the intermediate images can be set with a large degree of freedom, so that a sufficient range over which the intermediate images overlap with each other can be secured. The gap between the virtual images corresponding to the intermediate images can thus be reliably eliminated, so that the visibility of the virtual images can be significantly improved. As a result, the effects of providing appropriate information and reducing the stress on the observer can be further improved.

### Additional Remark 11

The head-up display apparatus according to any one of Additional Remarks 2 to 5, 7, 9 and 10, in which
an expression below is satisfied,
   D1−D2>D3,
      where D1: a width of each of the intermediate images in an arrangement direction of the light modulators,
      D2: a width of an effective image formed by each of the light modulators in the arrangement direction of the light modulators, and
      D3: a gap between the effective images formed by the light modulators in the arrangement direction of the light modulators.

When the expression described above is satisfied, the range over which the intermediate images overlap with each other can be sufficiently secured. The gap between the virtual images corresponding to the intermediate images can thus be reliably eliminated, so that the visibility of the virtual images can be significantly improved. As a result, the effects of providing appropriate information and reducing the stress on the observer can be further improved.

### Additional Remark 12

The head-up display apparatus according to any one of Additional Remarks 2 to 9 and 11, in which
the intermediate images adjacent to each other incline by different angles with respect to a wide axis parallel to an arrangement direction of the light modulators.

The range over which the intermediate images overlap with each other can be sufficiently secured as long as the angle of each of the intermediate images can be appropriately set. The gap between the virtual images corresponding to the intermediate images can thus be reliably eliminated, so that the visibility of the virtual images can be significantly improved. As a result, the effects of providing appropriate information and reducing the stress on the observer can be further improved.

### Additional Remark 13

The head-up display apparatus according to any one of Additional Remarks 1 to 12, in which
a diffusing optical element having a diffusion function is disposed at a position where the intermediate images are formed, and an expression below is satisfied:
   θ1<θ2
      where θ1: an angle of incidence of the light incident on the diffusing optical element, and
      θ2: an angle of emergence of the light emerging from the diffusing optical element.

The diffusion function provided at the position where the intermediate images are formed allows the angle of emergence θ2 to be greater than the angle of incidence θ1, so that a wide viewing angle can be secured. The visibility of the virtual images can thus be significantly improved, so that the effects of providing appropriate information and reducing the stress on the observer can be further improved.

### Additional Remark 14

A vehicle including
the head-up display apparatus according to any one of Additional Remarks 1 to 13.

The vehicle including the head-up display apparatus reduced in size can thus be realized. The display apparatuses, which constitute the head-up display apparatus, can each include a versatile image generator even when the vehicle is equipped with the head-up display apparatus, so that the cost can be suppressed.

What is claimed is:

1. A head-up display apparatus comprising:
two or more display apparatuses each configured to emit display light; and
a mirror configured to reflect the display light emitted from each of the display apparatuses,
wherein the display apparatuses each include an image generator configured to generate a video, a projection optical element configured to form an intermediate image corresponding to the video, and a display controller configured to control operation of displaying the video,
the intermediate images formed by the display apparatuses are so disposed that portions of the intermediate images overlap with each other so that a single overlapped intermediate image is created,
the display controller is configured to perform image processing on overlapping portions where the intermediate images overlap with each other in a way that a continuous video is created, and
the mirror is configured to reflect the display light from the overlapped intermediate image so as to be visually recognized as a virtual image by an observer.

2. The head-up display apparatus according to claim 1, wherein
the image generators each include a reflective modulator as a light modulator configured to form the display light.

3. The head-up display apparatus according to claim 1, wherein
the image generators each include a transmissive modulator as a light modulator configured to form the display light.

4. The head-up display apparatus according to claim 1, wherein
the image generators each include multiple light emitters as a light modulator configured to form the display light.

5. The head-up display apparatus according to claim 2, wherein
a size of the intermediate image is greater than a size of an effective image formed by the light modulator.

6. The head-up display apparatus according to claim 2, wherein
a size of the intermediate image is equal to a size of an effective image formed by the light modulator.

7. The head-up display apparatus according to claim 1, wherein
the projection optical elements each include multiple projection lenses configured to adjust a size of the intermediate image.

8. The head-up display apparatus according to claim 1, wherein
the projection optical elements each include a retroreflector.

9. The head-up display apparatus according to claim 1, wherein
the projection optical elements each include a plane-symmetric imaging optical element.

10. The head-up display apparatus according to claim 2, wherein
at least one of the multiple display apparatuses is so configured that a center axis of the light modulator is shifted in an arrangement direction of the light modulators from an optical axis of the projection optical element to overlap the intermediate images each other.

11. The head-up display apparatus according to claim 2, wherein
an expression below is satisfied,
D1−D2>D3,
where D1: a width of each of the intermediate images in an arrangement direction of the light modulators,
D2: a width of an effective image formed by each of the light modulators in the arrangement direction of the light modulators, and
D3: a gap between the effective images formed by the light modulators in the arrangement direction of the light modulators.

12. The head-up display apparatus according to claim 2, wherein
the intermediate images adjacent to each other incline by different angles with respect to a wide axis parallel to an arrangement direction of the light modulators.

13. The head-up display apparatus according to claim 1, wherein
a diffusing optical element having a diffusion function is disposed at a position where the intermediate images are formed, and an expression below is satisfied:
θ1<θ2
where θ1: an angle of incidence of the light incident on the diffusing optical element, and
θ2: an angle of emergence of the light emerging from the diffusing optical element.

14. A vehicle comprising
the head-up display apparatus according to claim 1.
